(19) United States
(12) Patent Application Publication
(10) Pub. No.: US 2016/0253877 A1
(43) Pub. Date: Sep. 1, 2016

(54) COMBINED BINGO AND KENO LOTTERY GAME

(71) Applicant: Intralot, Inc., Duluth, GA (US)

(72) Inventors: Scott R. Hoss, Cumming, GA (US); Lori Harris, Oakton, VA (US)

(73) Assignee: Intralot, Inc., Duluth, GA (US)

(21) Appl. No.: 15/151,549

(22) Filed: May 11, 2016

Related U.S. Application Data
(63) Continuation of application No. PCT/US2014/065605, filed on Nov. 14, 2014.
(60) Provisional application No. 61/905,921, filed on Nov. 19, 2013.

(51) Int. Cl. G07F 17/32; A63F 3/06

(52) U.S. Cl. CPC G07F 17/3267; G07F 17/329; A63F 3/06

(57) ABSTRACT

The object of a combined bingo and keno game is to fill in a prearranged pattern of numbers as in a bingo game and the selection of lucky numbers as in a keno game. As these numbers are called at random, a secondary game can be played simultaneously. This secondary game allows the players to select a designated quantity of lucky numbers and be rewarded for correctly selecting any or all of the lucky numbers. This secondary game is a game of chance styled after a traditional keno game in which players select a set of numbers in anticipation of the selected numbers matching, in identity and/or sequence, a series of randomly generated numbers or an undisclosed, preselected series of numbers. The players are rewarded based on the accuracy of their selections.

### CROSS REFERENCE TO RELATED APPLICATION

This is a continuation of PCT Application Publication No. WO 2015/077133 published May 28, 2015 from International Application No. PCT/US2014/065605, filed Nov. 14, 2014, which in turn claimed the benefit of U.S. Provisional Patent Application Ser. No. 61/905,921, filed on Nov. 19, 2013. Each of these prior applications is herein incorporated by reference in its entirety.

### BACKGROUND OF THE INVENTION

This invention relates to number games of chance such as lotteries, bingo and keno, for example. More particularly, this invention relates to a combined mode for playing such games and associated playing features.

Bingo is a popular game of chance in which cards from a set are distributed to players. Each card displays at least one bingo face, which includes a matrix of numbers. In the US, the bingo face is typically a 5×5 matrix, with each column of numbers listed under a letter of the word “bingo.” Numbers are announced or selected from a fixed pool of numbers that are used in the game, e.g., the numbers 1-75, labeled B1-B15, I16-I30, N31-N45, G46-G60 and O61-O75. Each bingo face includes a subset of these numbers. For example, under the letter “B,” five unique numbers selected from a subset of the numbers, 1 through 15 may be listed, and so forth. In Europe, bingo cards often have a larger matrix, with more or less than five columns, each column representing numbers in the units, tens, twenties, etc. Matrices of this type include spaces as well as numbers.

There are many different types of bingo games. In one type of game, all of the numbers are drawn for the game before any players view the arrangement of numbers on their bingo cards. The award is a predetermined amount. After the draw occurs, the players may purchase cards and compare the arrangements on the cards to the drawn numbers to determine whether one or more game-winning or other predetermined patterns are matched.

In live bingo games, the game is typically played by marking or filling in a bingo face as corresponding numbers are called from the pool. The numbers are called in a generally random or pseudo-random fashion. In some games, each of those numbers is represented by a ball in a large rotating bin. Each ball bears a unique one of the bingo numbers. The bin is rotated and one of the balls is randomly selected. The number on the selected ball is announced (and sometimes displayed) to the players. The players check each of their bingo cards to see if the announced number appears on the card. If the number appears on a card, the player marks that number on the card. When a player achieves a designated winning combination or pattern, the player wins the game if that player is the first person to achieve and announce such combination. This is often done by the person calling out “Bingo.”

The award for a typical bingo game is relatively small and depends on the number of players and the organizer's profit margin. Game designers are continually seeking to add interest and excitement to traditional games such as bingo. While bingo is a game which is commonly available in most jurisdictions, many jurisdictions have limitations and/or prohibitions on various other games, particularly as they relate to sponsored lotteries and gaming conducted over various electronic means. As such, enhancements to existing games and implementation of new games must naturally satisfy and comply with such regulations and limitations while still providing an enjoyable and worthwhile gaming experience to the player.

Moreover, to add excitement to the game, it would be advantageous for players to have the chance of winning a larger award.

Various objects and advantages of this invention over the prior art will become apparent to those skilled in the art upon reading the description of this invention together with the figures.

### SUMMARY OF THE INVENTION

In various embodiments of this invention, such as a combined bingo and keno game, the object is to fill in a prearranged pattern of symbols, letters or numbers. As these numbers are called at random, a secondary or bonus game can be played simultaneously according to various embodiments of this invention. This secondary or bonus game allows the players to guess a designated quantity of lucky numbers (i.e. guess one to ten lucky numbers or a subset of the numbers or symbols used in the primary bingo game) and be rewarded for correctly guessing any or all of the lucky numbers.

This secondary or bonus game is a game of chance implemented within a bingo game and styled after a traditional keno game in which players select or guess a set of numbers in anticipation of the selected numbers matching, in identity and/or sequence, a series of randomly generated numbers or an undisclosed, preselected series of numbers. The players are rewarded based on the accuracy of their guesses.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a flow chart of various embodiments of this invention;

FIG. 2 is an enlarged portion of the flow chart of FIG. 1;

FIG. 3 is an enlarged portion of the flow chart of FIG. 1;

FIG. 4 is an enlarged portion of the flow chart of FIG. 1;

FIG. 5 is an enlarged portion of the flow chart of FIG. 1;

FIG. 6 is an enlarged portion of the flow chart of FIG. 1;

FIG. 7 is an enlarged portion of the flow chart of FIG. 1;

FIG. 8 is an enlarged portion of the flow chart of FIG. 1;

FIG. 9 shows another embodiment of this invention; and

FIG. 10 is a block diagram for an exemplary apparatus for implementing this invention.

### DETAILED DESCRIPTION OF THE INVENTION

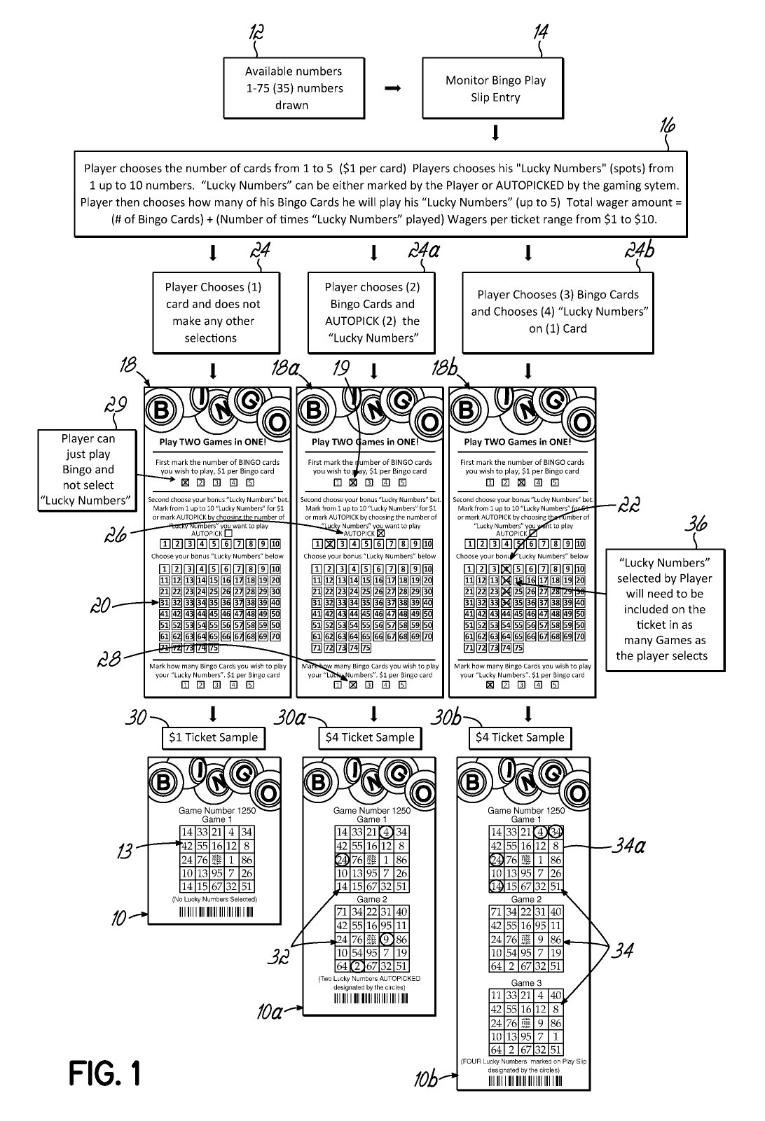

Examples of game cards for playing a lottery type game which combines bingo and keno type games constructed in accordance with various embodiments of this invention are illustrated generally at 10, 10a and 10b in FIG. 1. It will be recognized by those skilled in the art that the game cards depicted and described could be used during bingo type games. The game of bingo typically uses the set of symbols such as numbers one through seventy-five, but this is not a limitation on this invention as any set of numbers or symbols may be used. This is done for simplicity of illustration and discussion and is not intended to limit the scope of this invention. It will be recognized that the game card 10 and associated playing method of this invention are readily adaptable to combine with a keno type game, as seen in FIG. 1. The game card 10 could also be adapted for other types of lottery games which may call on the player to guess the identity and/or sequence of a subset or limited quantity of randomly generated numbers or symbols. The game card 10 and its associated playing method will be discussed first with reference to the game cards 10, 10a, 10b and associated play slips 18, 18a, 18b and with regard to the associated playing method and system. The game cards 10, 10a, 10b may be a physical, typically paper or paperboard, card, or a virtual or electronic representation of a card on a terminal, computer, Smartphone or other device. Moreover, this game and various embodiments of this invention may be implemented in a traditional bingo setting, a lottery environment, over the internet or many other modes.

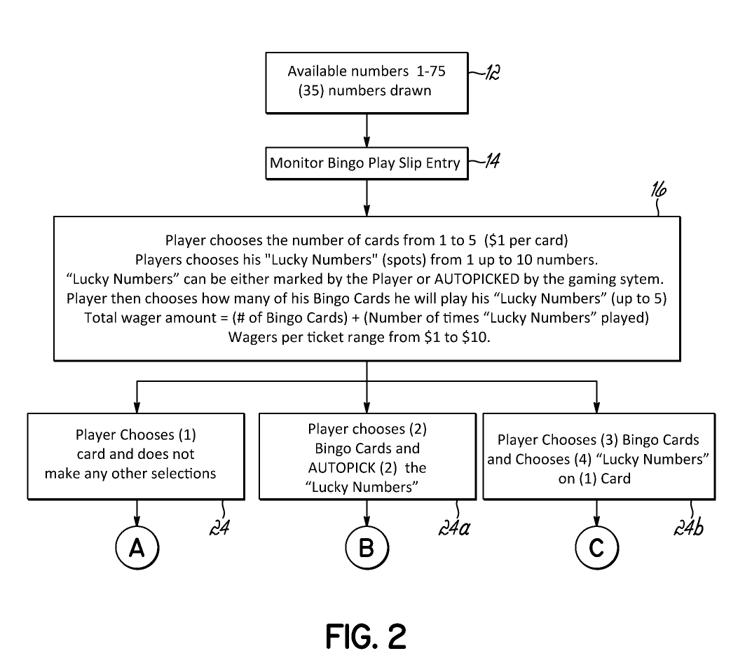

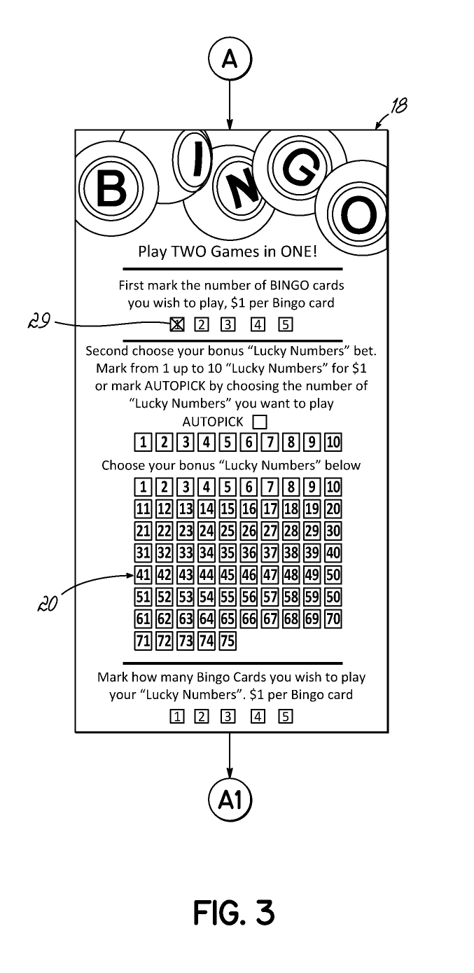

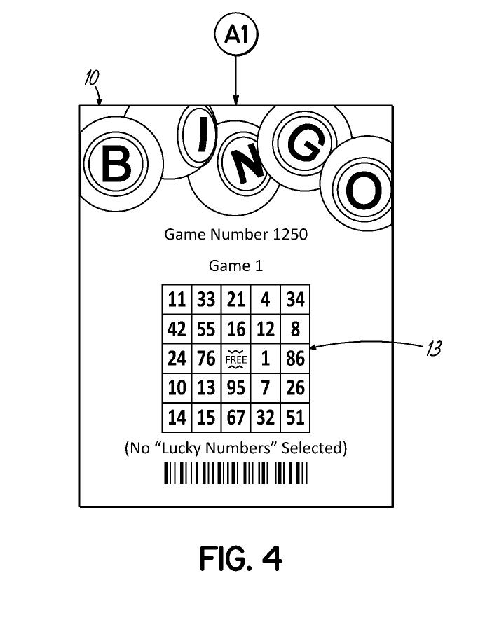

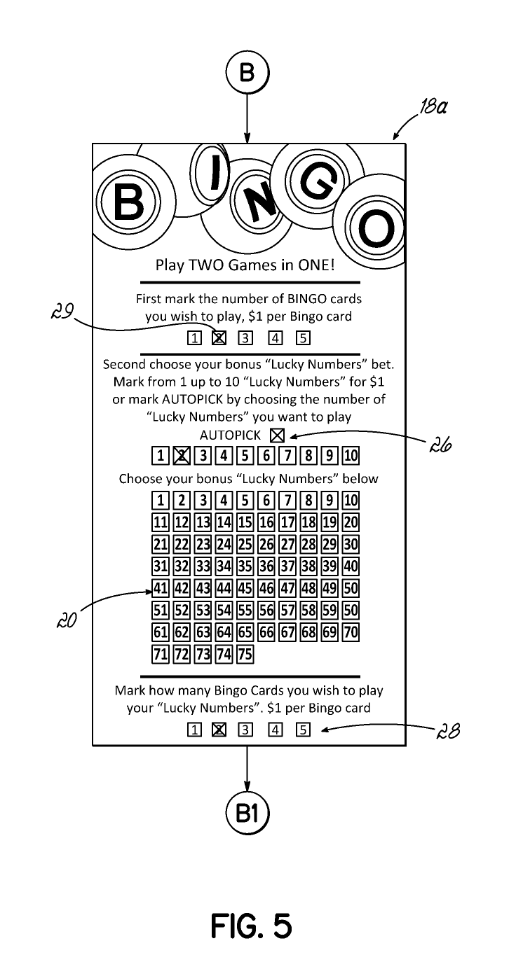

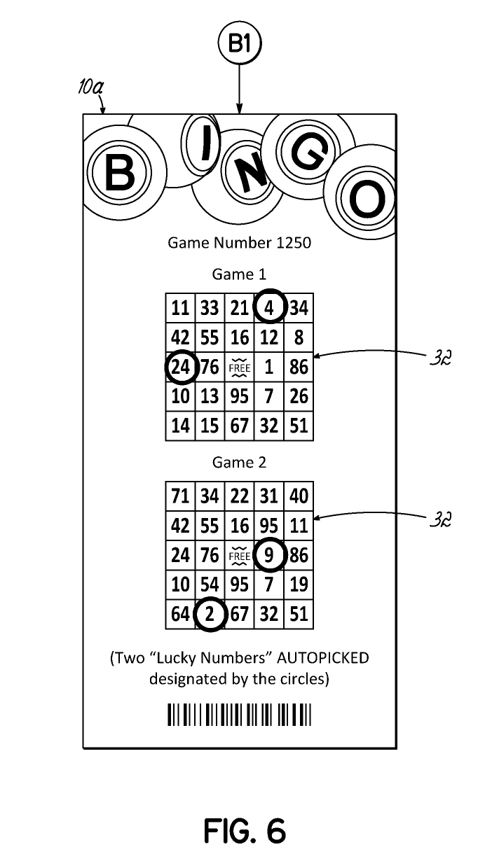

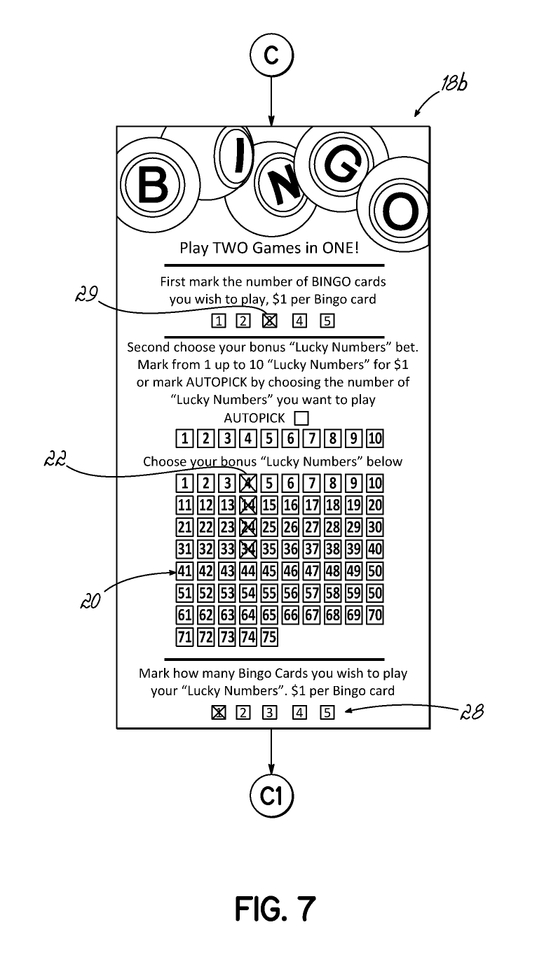

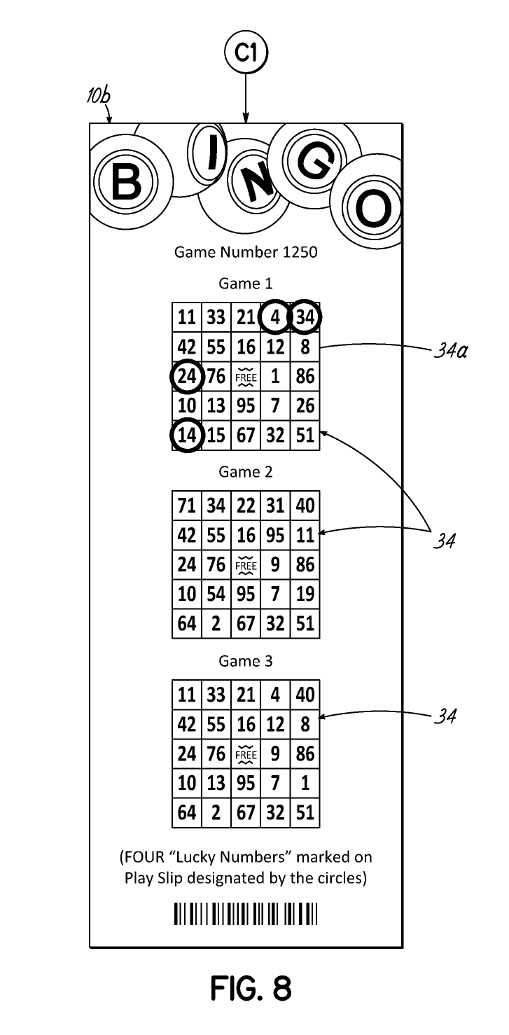

Referring to FIGS. 1-8, various exemplary embodiments of a combined bingo and keno game are shown. Particularly, FIG. 1 shows the overall method of playing the game according to this invention in three various embodiments. FIGS. 2-8 show the inventions of FIG. 1 in an expanded format. In particular, the embodiments of this game provide for a first set of symbols or numbers to be drawn from a second set of numbers as is common in traditional bingo game play. In particular, available numbers 20 may be 1-75 with 35 numbers to be drawn 12. A player may make selections 14 on a play slip 18, 18a, 18b and decides how many cards or game entries are to be played 16. In one embodiment, each card or game may be at a cost of one dollar. As a secondary feature of the game, the player may choose a subset of numbers as his or her “lucky numbers” and in the embodiment shown in FIGS. 1-9 up to 10 lucky numbers may be selected. In this regard, the player may utilize a play slip 18, 18a, 18b to indicate the number of bingo cards or games to be played. Alternatively, the game may proceed without the use of a play slip by having the player make selections electronically or otherwise.

As seen in FIG. 1, the play slip 18, 18a, 18b has a series of numbers 20, one through seventy-five in this embodiment. It will be recognized by those skilled in the art that for a keno type game, the numbers one through eighty could be used. Each number can be selected as a chosen as part of the subset or lucky number by making an appropriate mark 22 on or around the number. Play slip 18, 18a, 18b also has a field 19 to select the number of games to be played. The play slips 18, 18a, 18b may be read or scored by an optical reader/scanner such as is used to score standardized tests. While in the depicted embodiment, the play slip is scored by an optical scanning type device, it is understood that it could be manually scored. In an alternate embodiment, play slip would be graphically projected upon a computer monitor or other device such as is commonly used on coin-operated video games. The play slip would, in this embodiment, be computer scored.

The player may select 24, as previously described, up to 10 lucky numbers. The player may specifically select the lucky numbers from the first set 20 of 1-75 numbers by marking those selected numbers on the play slip. Alternatively, a player may choose to have their subset or lucky numbers auto-picked 26 at random by selecting the auto-pick selection as shown on the play slip 18a.

Another step in the game play process according to various embodiments of this invention is for the player to select 28 a number of bingo cards on which to play their selected or auto-pick lucky numbers. The selection 28 is made on the play slip 18a.

After the play slip 18, 18a, 18b is completed as desired by the player, a total wager amount 30 can be determined based upon the number of bingo cards selected 29 and the number of times any lucky numbers are played on those bingo cards 28.

Once the play slip is completed and payment is received from the player, the play slip may be submitted to the lottery authority, retailer, game operator or the like for processing and entry. The player may receive their lottery ticket or card 10, 10a, 10b according to their selections. For example, the lottery ticket 10 in column A of FIGS. 1-8 is an exemplary one dollar ticket for one game play without any lucky numbers selected. The resulting lottery ticket 10a from the selections in column B results in an exemplary four dollar ticket 30a in which two bingo games 32 are played and each bingo card includes two auto-picked lucky numbers 4 and 24 on one game and lucky numbers 2 and 9 on another game in the embodiment shown. The auto-pick subsets of numbers for each game are different as shown on the lottery ticket 10a in column B. The lottery ticket 10b resulting from the player selections in column C is an exemplary four dollar ticket 30b with three games 34 to be played with lucky numbers selected specifically by the player to be played in only one game 34a.

According to these various embodiments of the invention, a standard bingo game proceeds by the selection of thirty-five game numbers to be applied to the card or ticket 10, 10a, 10b. If any of the selected game numbers coincide with the identified subset of lucky numbers 36, a bonus or secondary prize is won by the player. As is customary in bingo games, different prize structures may be available depending on whether the player achieves various winning combinations on their bingo card (i.e., cover all, straight line, etc.) as previously described.

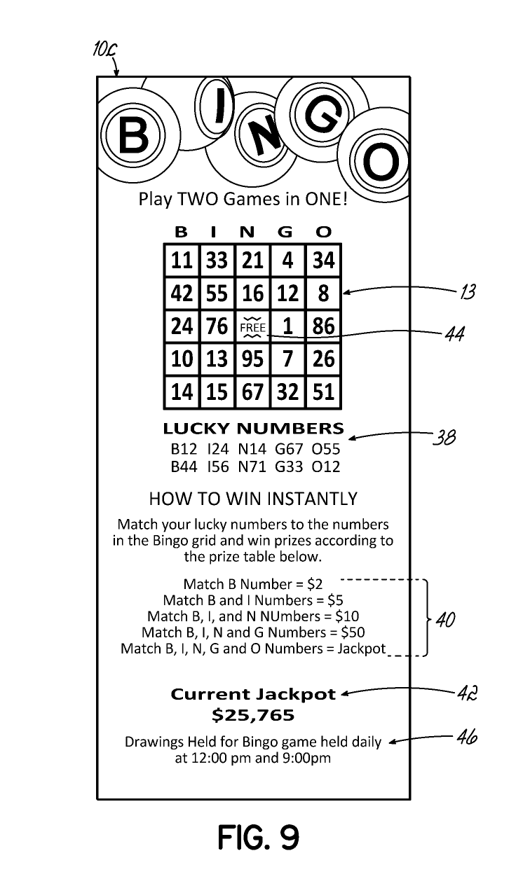

Referring to FIG. 9, an alternative embodiment of this invention is shown in which the subset or lucky numbers 38 may be either auto-picked, assigned or selected by the player. The selection of the lucky numbers 38 offers a bonus or secondary form of game play in addition to the traditional bingo game which may be conducted utilizing the bingo card 10c. The secondary game utilizing the lucky numbers 38 has various prize levels 40 and depending upon the matches, position and number of matches for the lucky numbers 38. The example shown in FIG. 9 indicates a two dollar secondary game winner if a number in the B column on the bingo card 10c is selected as a lucky number. If numbers in both the B and the I columns are selected for the lucky numbers 38, then a five dollar amount of secondary game winnings is obtained. If lucky numbers are present in each of the five columns then the jackpot 42 is won. The jackpot may be a progressive, rolling or fixed amount depending upon the game play and style.

In another embodiment according to this invention, a draw/instant win game is contemplated as shown in FIG. 9. When the player buys the bingo card 10c, he gets a randomly populated bingo face 13 with a free space 44 in the middle. A drawing may be held for that bingo game twice daily 46. The player wins by matching patterns. The player may also get randomly selected “lucky numbers” 38 that he can match to the bingo face 13 to win instantly. The top prize for the instant win may be a progressive jackpot 42.

As explained above, various embodiments of this invention include a secondary or bonus game 10a, 10b that may be played during bingo type games calls on the players to guess the identity and/or sequence of a subset of numbers 36, 38 from a designated set of numbers, such as the first fifteen bingo numbers called during a single game of bingo. The player would also be credited in the bingo game with a correct guess if one of the lucky numbers were called, thus the player perceives greater odds of guessing correctly.

Various prizes or the like may be awarded for game winning outcomes. The prizes may comprise goods, services, points or money or representations thereof, or other types of awards, such as recognition. For example, when the game is played as a wagering game, the prizes may comprise monetary awards. The particular prizes for the various outcomes may vary, such as in accordance with a pay table. In other embodiments, awards may change in value, such as in the form of a jackpot or progressive jackpot, mystery prize or the like. Also, awards may be divided among multiple players or vary based upon the size of wager, type of game card being played or other criteria.

One object for each of the players is to be the first to complete a predetermined configuration on the bingo face 13 and thereby have a winning bingo card 10. Thereafter, the bingo card holder may be eligible for an additional award based on the secondary or bonus game ii of lucky numbers 36, 38. In one exemplary embodiment, the object is to have a FULL HOUSE (cover all) on one of the bingo faces 13, which occurs when every number on the bingo face 13 has been called. However, it is to be appreciated that in other embodiments, other configurations may be selected for identifying a winning bingo card 10, such as configurations where only one or only two lines are covered or where a configuration such as a “picture frame” of numbers (i.e., only the numbers on the outer periphery of the bingo face) is covered.

In alternate embodiments of the associated playing method, the player could also be rewarded for correctly guessing the identity of a selected quantity of randomly generated numbers regardless of whether player has correctly guessed the number's sequence.

Moreover, while specific embodiments of this invention are disclosed with respect to bingo and keno game play, the invention in other embodiments may utilize bingo and/or keno with other games or games other than bingo and keno in combination.

In various embodiments, this invention combines bingo and keno play styles in a unique and innovative way. One aspect is matching just “lucky numbers” 36, 38 in a bingo game as opposed to a line or pattern. This may comply with legislation that does not allow keno by allowing a player to play bingo with what is essentially a keno bet with 75 numbers available instead of 80 in keno and drawing 35 as opposed to 20 in keno. For example, when a player selects their lucky numbers 36, 38 for play in more than one bingo card 10, those lucky numbers automatically may be included in some or all of the bingo cards 10a to be played. The player can make the choice to include his “lucky numbers” 36, 38 on one, more than one, up to all five bingo plays but the player must make that selection 28 on the play slip 18, 18a, 8b. The bingo game is played by a set of numbers being randomly generated and then applied to each bingo card 10, 10a, and 10b and if a line or cover all of the numbers is generated on the card, the player is a winner at a predetermined level. If the subset of lucky numbers 36, 38 are included in the drawn numbers, then a bonus prize is earned. Essentially the player must play bingo and his bingo card is randomly generated for bingo. He can elect to spend an extra one dollar per bingo card to select or have the system select from 1-10 lucky numbers per bingo card. He can play those lucky numbers on as many bingo games as he wants from 1-5. The “lucky numbers” he plays may be the same lucky numbers for each card on a single purchase.

Suitable examples of gaming devices of this invention which may be specialized and adapted for this invention include video and non-video lottery terminals, virtual lottery draw machines, slot machines, video poker machines, digital roulette machines, hand-held cell phones or other personal digital assistants, web sites, POS TV monitors, touch-screens and others. Conceptual principles of a system for implementing a network-based lottery game wherein players are given access to a network game site for play of a lottery game having a predetermined outcome according to various embodiments of this invention include the following. It should be understood that this invention, system and associated methods are not limited by any particular type of game, and the term “lottery game” is used herein to denote any type of probability-based game offered to eligible persons. The games may be presented to players purely for entertainment value at no cost to the player. Prizes may be awarded to a player for a winning game play, which may include a cash award. In other embodiments, the player places a wager amount for play of the lottery game in the hopes of winning a cash award or other type of prize.

The game may be administered by a lottery provider, which is the entity that provides a lottery to a gaming authority or administrator. In an alternate embodiment, the lottery provider and gaming authority may be the same entity. The gaming authority may be, for example, a state or other regional governmental entity that provides lottery games to eligible players via authorized retailers or retail establishments. In the United States, for example, the gaming authority may be a state or affiliation of states that offers lottery games to their residents via the sale of lottery games at authorized retail establishments.

The gaming authority typically utilizes a central host computer system in communication with the various retail establishments, particularly the lottery terminals maintained at the retail establishments (also referred to as point-of-sale terminals). Typically, a vast number of such terminals are operatively coupled to the central host computer system via any suitable communications network, which may be, for example, the Internet, a wide area network (WAN), a local area network (LAN), a telephone system, and so forth. In a particular embodiment, the lottery network may include a state lottery system operating within an individual state or region of states, wherein the lottery terminals are interconnected to the game administrator and host computer server directly or through an intermediary network for tracking, administration, and coordination of the state lottery system, including control of issued tickets, prizes, amounts wagered, and so forth. It should be readily appreciated that this invention encompasses any suitable communications network architecture that provides the lottery player with the ability to communicate and interact with the game administrator's central host computer system 18.

The point-of-sale terminals or other gaming device may include any conventional feature known to those skilled in the art related to lottery terminals. The terminal includes features and functionality to allow a player or retail clerk to enter the information required to participate in the lottery game. An exemplary terminal includes a housing, one or more input devices, which may be a control panel having input keys, a display, a value input device such as a card reader, a play slip or ticket reader, and a ticket printer. The play slip reader is typically configured to read user selection marks, bar codes, magnetically stored information, or any other desired input information and may be omitted in various embodiments. Control panel input keys allow the player or retail clerk to select the game to be played, input the value to be wagered, manually enter selected lottery characters (if needed), and input any other information necessary to play the lottery game. The terminal may include a display which may be an LCD, a CRT, or touch-screen capable of receiving and displaying information related to the game. The value input device may include any device that can accept value or a wager from a customer, such as a card reader or an optical currency collector. The value input device may be integrated with external devices, such as a cash register or other retail terminals, to exchange information necessary to receive and record the wagering transaction. The player may also draw from a player's account with the lottery. The lottery ticket printer may be used to print or otherwise encode lottery tickets with information selected or required to play the lottery game. The printer may provide lottery tickets that reflect a player's selections, or complete lottery slips if the selection was generated automatically by the terminal.

The host computer system may be a single networked computer or a series of interconnected computers having access to the lottery system or network via any suitable networking system. Generally, such computer systems are configured to manage, execute, and control the individual lottery terminals and the routines used to play various lottery games, or track information related to the sale and distribution of pre-printed instant lottery tickets, such as scratch-off lottery tickets. The host computer may include memory for storing lottery programs, files, and routines, a microprocessor for executing stored routines, random access memory (RAM), and an input/output (I/O) bus. In addition, the host computer may be in communication with any manner of external device, including external databases. Such databases may provide a data repository for the storage and correlation of information gathered from the individual lottery terminals relating to the individual terminals, such as terminal specific information like the machine ID, sales establishment, location, and ticket-specific information. It should be readily appreciated that the host computer 12, 18 may encompass any configuration of hardware and software applications necessary to manage, execute, and control administration of the lottery game.

A game server system may be provided with any suitable hardware and software configuration for enabling play of network-based lottery games whereby players access a game site (e.g., an Internet site) maintained by the game server system via a network-enabled device and communications network. The network-enabled device may be, for example, a personal computer, smart phone, personal digital assistant (PDA), or other intelligent communications device. The communication network may be, for example, the Internet, a wide area network (WAN), a local area network (LAN), a telephone system, and so forth. In a particular embodiment, the game server system maintains an Internet game site accessible to players via the Internet.

It should be appreciated that this game system and method are not limited to an Internet implementation, but encompass any system configuration wherein players are provided access to a game site via a communications network. This network may be a WAN or LAN provided, for example, solely to patrons of certain establishment, such as a casino or other type of gaming house.

A game playing system according to one embodiment of this invention may include a number of components for performing specific functions. The components may include, for example, storage components for data structures for storing game variations, present game session information, game session history, and win history. A game playing and viewing system may also include components used to access the payment and payout data structures.

The game playing and viewing system according to one embodiment of this invention may also include a game engine or program. A game engine may perform numerous functions, including drawing winning elements for a game and displaying the drawn winning elements through any communication means, including on a lottery terminal, over the Internet (e.g., through a website or internet messaging, or e-mail), or by text messaging on a cell phone. The game playing and viewing system may also receive communication from players indicating a winning game ticket. Communication may be received using any method, including over the Internet (e.g., through a website, Internet messaging, or e-mail) or by text messaging on a cell phone.

Acts described above and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a number of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described below, and may be distributed across one or more of such components.

The computer-readable medium may be transportable such that the instructions stored thereon can be loaded onto any computer system resource to implement the aspects of this invention discussed herein. In addition, it should be appreciated that the instructions stored on the computer-readable medium are not limited to instructions embodied as part of an application program running on a host computer. Rather, the instructions may be embodied as any type of computer code (e.g., software or microcode) that can be employed to program a processor to implement the above-discussed aspects of this invention.

It should be appreciated that any single component or collection of multiple components of a computer system, e.g., the computer system described below, that performs the functions described above can be generically considered as one or more controllers that control the above-discussed functions. The one or more controllers can be implemented in numerous ways, such as with dedicated and specialized hardware, or using a processor that is programmed using microcode or software to perform the functions recited above.

Another component of the game playing and viewing system may be a driver that streams video via a broadband, satellite, or wireless medium to a user interface. If the game is played completely automatically, the user interface may be merely a video terminal including television with no user input means. Viewing access may be controlled by standard means for conditional access including using set top box addresses, telephone numbers or Internet protocol (IP) addresses.

The above is merely an illustrative embodiment of a game playing and viewing system. Such an illustrative embodiment is not intended to limit the scope of the invention, as any of numerous other implementations of a game playing and viewing system; for example, variations of conditional access are possible and are intended to fall within the scope of the invention. This invention is not intended to be limited to any particular implementation of a game playing and viewing system unless such claim includes a limitation explicitly reciting a particular implementation.

This invention and components thereof such as the payment, payout, and game engines, may be implemented using software (e.g., C, C#, C++, Java, or a combination thereof), hardware (e.g., one or more application-specific integrated circuits, processors or other hardware), firmware (e.g., electrically-programmed memory), or any combination thereof. One or more of the components may reside on a single system (e.g., the payment subsystem), or one or more components may reside on separate, discrete systems. Further, each component may be distributed across multiple systems, and one or more of the systems may be interconnected.

Further, on each of the one or more systems that include one or more components, each of the components may reside in one or more locations on the system. For example, different portions of the components may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

This invention may be implemented on a computer system described below. Computer system is merely an illustrative embodiment of a game system. Such an illustrative embodiment is not intended to limit the scope of the invention, as any of numerous other implementations of the game system, for example, variations of the system, are possible and are intended to fall within the scope of the invention. None of the claims set forth below are intended to be limited to any particular implementation of the game system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. Moreover, cloud based hosting may be utilized with this invention. It should be appreciated that one or more of any type computer system may be used to partially or fully automate play of the described game according to various embodiments of the invention. Further, the software design system may be located on a single computer or may be distributed among a plurality of computers attached by a communications network.

A computer system according to one embodiment of the invention may be specially configured to perform any of the described game functions including, but not limited to, player subscription or payment, player chosen elements or elements chosen for the player, drawing winning elements, and communicating with, verifying, and paying winners. It should be appreciated that the system may perform other functions, including network communication, and the invention is not limited to having any particular function or set of functions.

For example, various aspects of the invention may be implemented as specialized software executing in a specially adapted computer system. The computer system may include a processor connected to one or more memory devices, such as a disk drive, memory, or other device for storing data. Memory is typically used for storing programs and data during operation of the computer system. Components of computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components of system. Computer system also includes one or more input devices, for example, a keyboard, mouse, trackball, microphone, touch screen, and one or more output devices, e.g., a printing device, display screen, or speaker. In addition, computer system may contain one or more interfaces that connect computer system to a communication network in addition or as an alternative to the interconnection mechanism.

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in storage system or in memory system. The processor generally manipulates the data within the integrated circuit memory and then copies the data to the medium after processing is completed. A variety of mechanisms are known for managing data movement between the medium and the integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system is disclosed by way of example as one type of computer system upon which various aspects of the invention may be practiced, it should be appreciated that aspects of the invention are not limited to being implemented on the computer system as described herein. It should be appreciated that various aspects of the invention may be practiced on one or more computers having a different architecture or components than that disclosed herein.

Computer system may be a general-purpose computer system that is programmable using a high-level computer programming language. Computer system may be also implemented using specially programmed, special purpose hardware. In computer system, the processor is typically a commercially available processor such as the well-known Pentium class processor available from the Intel Corporation. Many other processors are available. Such a processor usually executes an operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

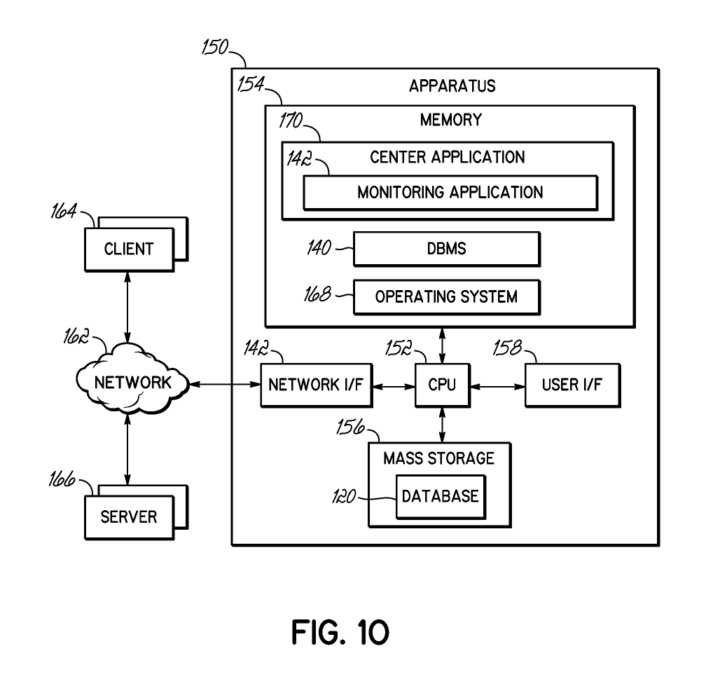

Now turning to FIG. 10, an exemplary hardware and software implementation of a game, within an apparatus 150, is illustrated. For the purposes of the invention, apparatus 150 may represent practically any type of computer, computer system or other programmable electronic device, and will be referred to hereinafter as a computer for simplicity. It will be appreciated, however, that apparatus 150 may be implemented using one or more networked computers, e.g., in a cluster or other distributed computing system, or may be implemented within a single computer or other programmable electronic device, e.g., a desktop computer, laptop computer, handheld computer, cell phone, set top box, etc.

Computer 150 typically includes a central processing unit 152 including at least one microprocessor coupled to a memory 154, which may represent the random access memory (RAM) devices comprising the main storage of computer 150, as well as any supplemental levels of memory, e.g., cache memories, non-volatile or backup memories (e.g., programmable or flash memories), read-only memories, etc. In addition, memory 154 may be considered to include memory storage physically located elsewhere in computer 150, e.g., any cache memory in a processor in CPU 152, as well as any storage capacity used as a virtual memory, e.g., as stored on a mass storage device 156 or on another computer coupled to computer 150. Computer 150 also typically receives a number of inputs and outputs for communicating information externally. For interface with a user or operator, computer 150 typically includes a user interface 158 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 150 may also include one or more mass storage devices 156, e.g., a floppy or other removable disk drive, a hard disk drive, a direct access storage device (DASD), an optical drive (e.g., a CD drive, a DVD drive, etc.), and/or a tape drive, among others. Furthermore, computer 150 may include an interface with one or more networks 162 (e.g., a LAN, a WAN, a wireless network, and/or the Internet, among others) to permit the communication of information with other computers and electronic devices, e.g., one or more client computers 164 (e.g., for interfacing with agents) and one or more servers 166 (e.g., implementing other aspects of the game). It should be appreciated that computer 150 typically includes suitable analog and/or digital interfaces between CPU 152 and each of components 154, 156 and 158 as is well known in the art. Other hardware environments are contemplated within the context of the invention.

Computer 150 operates under the control of an operating system 168 and executes or otherwise relies upon various computer software applications, components, programs, objects, modules, data structures, etc., e.g., a call center application 170 (within which, for example, monitoring application 142 may be implemented). Moreover, various applications, components, programs, objects, modules, etc. may also execute on one or more processors in another computer coupled to computer 150 via network 162, e.g., in a distributed or client-server computing environment, whereby the processing required to implement the functions of a computer program may be allocated to multiple computers over a network.

In general, the routines executed to implement various embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be accessed by computer 150. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL), or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of this invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML, or other format that, when viewed in a window of a browser program, render aspects of a graphical-user interface (GUI) or perform other functions). Various aspects of the invention may be implemented as programmed or non-programmed elements, or any combination thereof.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A method of conducting at least one game involving a set of symbols, the method comprising the steps of:
processing player selections from each of a plurality of players, the player selections including,
(A) an indication of the quantity of games the player wishes to play,
(B) whether the player wishes to participate in any additional bonus games, if the player wishes to participate in additional bonus games,
(1) the quantity of bonus games the player wishes to participate in,
(2) at least one subset of the symbols to be played in at least one bonus game;
issuing to each player a game card including the player's selections;
determining whether each player is a winner of each of the quantity of games; and
determining whether each player is a winner of any additional bonus games.

2. The method of claim 1 wherein the set of symbols comprises numbers.

3. The method of claim 1 wherein at least one of the games is a Bingo style game.

4. The method of claim 1 wherein the issuing step further comprises one of printing a physical ticket and generating an electronic ticket as the game card.

5. The method of claim 1 further comprising:
calculating purchase price for the game card to be paid by the player based on the player selections.

6. The method of claim 1 wherein the player selections further comprise:
a plurality of subsets of symbols, each subset being played in a distinct bonus game.

7. The method of claim 1 wherein the player selections further comprise the step of:
randomly generating each subset of symbols for the player in response to a player request to do so.

8. The method of claim 1 wherein each additional bonus game is a Keno style game.

9. The method of claim 1 wherein a plurality of bonus games are selected by the player and a plurality of subsets of the symbols are played by the player with each of the subsets of symbols being played in only one of the plurality of bonus games.

10. The method of claim 1 wherein a plurality of bonus games are selected by the player and the at least one subset of the symbols is played in each of the plurality of bonus games.

11. The method of claim 3 wherein each additional bonus game is a Keno style game.

12. The method of claim 1 wherein each of the symbols in the subsets of symbols is played in both the at least one game and each of the bonus games.

13. The method of claim 1 wherein the at least one game is a different game from each of the bonus games.

14. The method of claim 1 wherein each of the player selections is limited to a single one of the symbols.

15. A method of conducting at least one game involving a set of numbers, the method comprising the steps of:
processing player selections from each of a plurality of players, the player selections including,
(A) an indication of the quantity of games the player wishes to play,
(B) whether the player wishes to participate in any additional bonus games, if the player wishes to participate in additional bonus games,
(1) the quantity of bonus games the player wishes to participate in,
(2) at least one subset of the numbers to be played in at least one bonus game;
issuing to each player a game card including the player's selections;
determining whether each player is a winner of each of the quantity of games; and
determining whether each player is a winner of any additional bonus games;
wherein each of the numbers in the subsets of numbers is played in both the at least one game and each of the bonus games.

16. The method of claim 15 wherein at least one of the games is a Bingo style game and each additional bonus game is a Keno style game.

17. The method of claim 15 wherein the player selections further comprise:
a plurality of subsets of numbers, each subset being played in a distinct bonus game.

18. The method of claim 15 wherein the player selections further comprise the step of:
randomly generating each subset of numbers for the player in response to a player request to do so.

19. The method of claim 15 wherein each of the symbols in the subsets of symbols is played in both the at least one game and each of the bonus games and each of the player selections is limited to a single one of the symbols.

20. A method of conducting at least one Bingo style game involving a set of numbers, the method comprising the steps of:
processing player selections from each of a plurality of players, the player selections including,
(A) an indication of the quantity of Bingo style games the player wishes to play,
(B) whether the player wishes to participate in any additional Keno style bonus games,
if the player wishes to participate in additional Keno style bonus games,
(1) the quantity of Keno style bonus games the player wishes to participate in,
(2) at least one subset of the numbers to be played in at least one Keno style bonus game;
issuing to each player a game card including the player's selections;
determining whether each player is a winner of each of the quantity of Bingo style games; and
determining whether each player is a winner of any additional Keno style bonus games;
wherein each of the numbers in the subsets of numbers is played in both the at least one Bingo style game and each of the Keno style bonus games.
